(19) United States
(12) Patent Application Publication
(10) Pub. No.: US 2015/0139235 A1
(43) Pub. Date: May 21, 2015

(54) PACKET PROCESSING APPARATUS USING ACTION COMMAND PARAMETERIZATION

(71) Applicant: MEDIATEK INC., Hsin-Chu (TW)

(72) Inventors: Kuo-Cheng Lu, Hsinchu City (TW); Yi-Hung Chen, Yilan County (TW); Chang-Due Young, Kaohsiung City (TW)

(21) Appl. No.: 14/469,607

(22) Filed: Aug. 27, 2014

Related U.S. Application Data
(60) Provisional application No. 61/907,378, filed on Nov. 21, 2013.

(51) Int. Cl. H04L 12/741; H04L 12/947; H04L 12/931

(52) U.S. Cl. CPC H04L 45/745; H04L 49/354; H04L 49/25
USPC 370/392

(57) ABSTRACT

A packet processing apparatus has an ingress packet processing circuit, an egress packet processing circuit, a traffic manager, and a processor. The ingress packet processing circuit processes an ingress packet received from an ingress port to generate at least one parameter. The egress packet processing circuit has at least one programmable look-up table, refers to the at least one parameter to determine at least one action command set, and executes the at least one action command set for generating an egress packet to be forwarded through an egress port. The traffic manager is coupled between the ingress packet processing circuit and the egress packet processing circuit. The processor programs the at least one programmable look-up table. No action command in the at least one action command set is transmitted from the ingress packet processing circuit to the egress packet processing circuit through the traffic manager.

### CROSS REFERENCE TO RELATED APPLICATIONS

This application claims the benefit of U.S. provisional application No. 61/907,378, filed on Nov. 21, 2013 and incorporated herein by reference.

### BACKGROUND

The disclosed embodiments of the present invention relate to forwarding packets, and more particularly, to a packet processing apparatus using action command parameterization.

A network switch is a computer networking device that links different electronic devices. For example, the network switch may receive an incoming packet generated from a first electronic device connected to it, and may transmit a modified packet derived from the received packet only to a second electronic device for which the received packet is meant to be received. In general, a network switch includes an ingress packet processing circuit, an egress packet processing circuit, and a traffic manager, where the traffic manager is coupled between the ingress packet processing circuit and the egress packet processing circuit. However, the conventional traffic manager has a limited bandwidth, and is unable to carry too much information (e.g., action commands) from the ingress packet processing circuit to the egress packet processing circuit. Further, the conventional ingress packet processing circuit may generate and transmit one action command for one packet modification needed to be applied to a packet in the egress packet processing circuit. As a result, different combinations of packet modifications would result indifferent combinations of action commands. The complexity of action commands may be high, leading to an action command explosion issue.

Thus, there is a need for an innovative packet processing design that is capable of reducing the bandwidth usage of the traffic manager and avoiding the action command explosion issue.

### SUMMARY

In accordance with exemplary embodiments of the present invention, a packet processing apparatus using action command parameterization is proposed to solve the above-mentioned problem.

According to a first aspect of the present invention, an exemplary packet processing apparatus is disclosed. The exemplary packet processing apparatus includes an ingress packet processing circuit, an egress packet processing circuit, a traffic manager, and a processor. The ingress packet processing circuit is configured to process an ingress packet received from an ingress port to generate at least one parameter. The egress packet processing circuit has at least one programmable look-up table, and is configured to refer to the at least one parameter to determine at least one action command set, and execute the at least one action command set for generating an egress packet to be forwarded through an egress port. The traffic manager is coupled between the ingress packet processing circuit and the egress packet processing circuit. The processor is configured to program the at least one programmable look-up table. No action command in the at least one action command set is transmitted from the ingress packet processing circuit to the egress packet processing circuit through the traffic manager.

According to a second aspect of the present invention, an exemplary packet processing apparatus is disclosed. The exemplary packet processing apparatus includes an ingress packet processing circuit, an egress packet processing circuit, a traffic manager, and a processor. The ingress packet processing circuit has at least one programmable look-up table, and is configured to process an ingress packet received from an ingress port to generate at least one parameter. The egress packet processing circuit is configured to refer to the at least one parameter to determine at least one action command set, and execute the at least one action command set for generating an egress packet to be forwarded through an egress port. The traffic manager is coupled between the ingress packet processing circuit and the egress packet processing circuit. The processor is configured to program the at least one programmable look-up table. No action command in the at least one action command set is transmitted from the ingress packet processing circuit to the egress packet processing circuit through the traffic manager.

According to a third aspect of the present invention, an exemplary packet processing apparatus is disclosed. The exemplary packet processing apparatus includes an ingress packet processing circuit, an egress packet processing circuit, and a traffic manager. The ingress packet processing circuit is configured to process an ingress packet received from an ingress port to generate at least one parameter. The egress packet processing circuit is configured to refer to the at least one parameter to set at least one action command set, and execute the at least one action command set for generating an egress packet to be forwarded through an egress port. The traffic manager is coupled between the ingress packet processing circuit and the egress packet processing circuit. The packet processing apparatus is a software-defined networking (SDN) switch. No action command in the at least one action command set is transmitted from the ingress packet processing circuit to the egress packet processing circuit through the traffic manager.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a packet processing apparatus according to an embodiment of the present invention.

FIG. 2 is a diagram illustrating a first action command set determined at an egress packet processing circuit based on a single first parameter generated from an ingress packet processing circuit according to an embodiment of the present invention.

FIG. 3 is a diagram illustrating a second action command set determined at the egress packet processing circuit based on two second parameters included in the at least one parameter generated from the ingress packet processing circuit according to an embodiment of the present invention.

FIG. 4 is a diagram illustrating a third action command set determined at the egress packet processing circuit based on two third parameters included in the at least one parameter generated from the ingress packet processing circuit according to an embodiment of the present invention.

FIG. 5 is a diagram illustrating different combinations of action commands determined by different action command sets.

FIG. 6 is a diagram illustrating a first action command set determined at an egress packet processing circuit based on a single parameter generated from the ingress packet processing circuit according to an embodiment of the present invention.

FIG. 7 is a diagram illustrating different combinations of action commands determined by different egress port numbers according to the action command parameterization design shown in FIG. 6.

FIG. 8 is a diagram illustrating a second action command set determined at an egress packet processing circuit based on a single parameter generated from the ingress packet processing circuit according to an embodiment of the present invention.

FIG. 9 is a diagram illustrating different combinations of action commands determined by different egress port numbers according to the action command parameterization design shown in FIG. 8.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

The present invention proposes converting action command sets into parameterized action command sets (which are composed of parameters representative of the action command sets only), and transmitting the parameterized action command sets from an ingress packet processing circuit to an egress packet processing circuit through a traffic manager. Hence, the egress packet processing circuit recovers the action command sets from the parameters carried via the parameterized action command sets, and then executes the action command sets for egress packet generation. Since operands and operators of the action command sets are parameterized, the parameterized action command sets have smaller size (i.e., smaller bit count) when compared to the original action command sets. Hence, the bandwidth usage of transmitting the parameterized action command sets (i.e., parameters representative of the action command sets) through the traffic manager is low.

Moreover, due to converting action command sets into parameters, each action command in an action command set can be individually determined at the egress packet processing circuit. In this way, the action command explosion issue can be avoided. Further details of the proposed packet processing architecture are detailed as below.

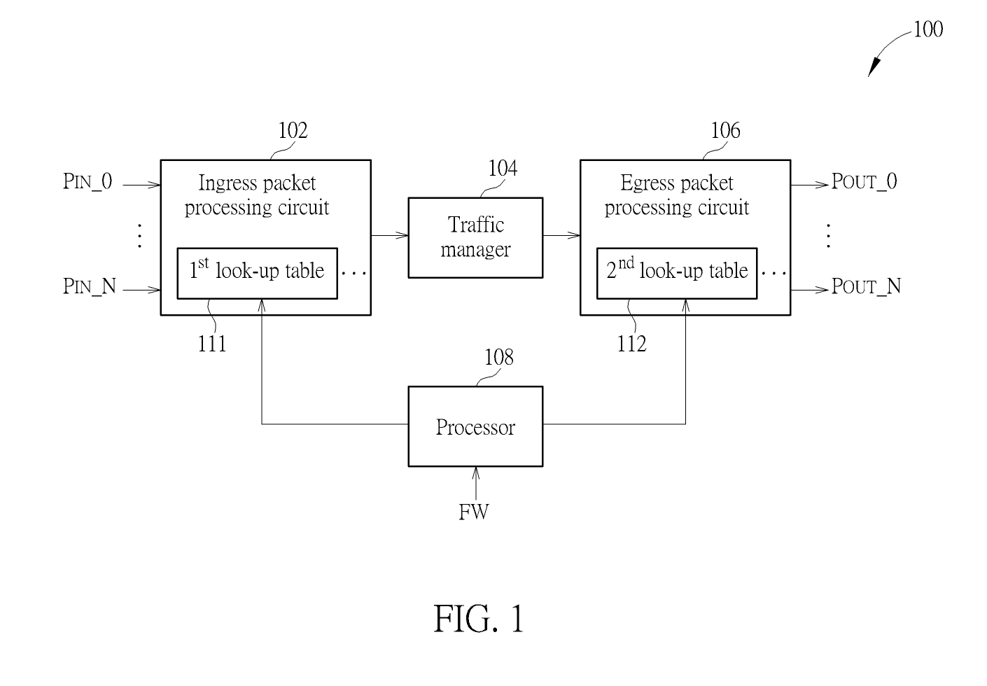

FIG. 1 is a diagram illustrating a packet processing apparatus according to an embodiment of the present invention. In this embodiment, the packet processing apparatus 100 includes an ingress packet processing circuit (e.g., an ingress packet processing pipeline) 102, a traffic manager 104, an egress packet processing circuit (e.g., an egress packet processing pipeline) 106, and a processor 108. By way of example, but not limitation, the packet processing apparatus 100 may be a software-defined networking (SDN) switch. Hence, one or both of the ingress packet processing circuit 102 and the egress packet processing circuit 106 may be programmable. The processor 108 may execute software (e.g., firmware FW of the SDN switch) to program (e.g., set or modify) at least one first look-up table 111 included in the ingress packet processing circuit 102 and at least one second look-up table 112 included in the egress packet processing circuit 106. However, this is for illustrative purposes only, and is not meant to be a limitation of the present invention.

It may be difficult to directly transmit certain commands from an ingress packet processing circuit to an egress packet processing circuit through a traffic manager. To solve this issue, the present invention proposes parameterizing the commands at the ingress packet processing circuit 102 and then transmitting parameterized commands (i.e., parameters representative of the commands) from the ingress packet processing circuit 102 to the egress packet processing circuit 106 through the traffic manager 104.

In accordance with the proposed packet processing architecture, the packet processing apparatus may have an ingress packet processing circuit with programmable look-up table(s) and/or an egress packet processing circuit with programmable look-up table(s). In this way, the design of generating parameters at the ingress packet processing circuit and/or the design of recovering action command sets from parameters at the egress packet processing circuit can be programmed to meet different application requirements.

Since the packet processing apparatus 100 is equipped with packet switching capability, the packet processing apparatus 100 therefore have a plurality of external ports, including ingress ports P_{IN}_{_{—}}₀-P_{IN}_{_{—}}_{N} and egress ports P_{OUT}_{_{—}}₀-P_{OUT}_{_{—}}_{N}, for receiving ingress packets generated from external source network devices and forwarding egress packets to external destination network devices, where N is a positive integer value which may be adjusted based on the actual design consideration.

The ingress packet processing circuit 102 is configured to process ingress packets received from ingress ports P_{IN}_{_{—}}₀-P_{IN}_{_{—}}_{N}. The egress packet processing circuit 106 is configured to process egress packets to be forwarded through egress ports P_{OUT}_{_{—}}₀-P_{OUT}_{_{—}}_{N}, where an egress packet may be generated by applying one or more packet modifications to an ingress packet. For example, the ingress packet processing circuit 102 may be configured to perform packet header extraction and classification (e.g., extract a packet header of an ingress packet and perform packet classification based on the extracted packet header). The egress packet processing circuit 106 may be configured to perform action command execution (e.g., execute one or more action commands decided based on the identified packet header).

Further, there is the traffic manager 104 coupled between the preceding ingress packet processing circuit 102 and the following egress packet processing circuit 106. The traffic manager 104 may be configured to deal with at least packet queuing and scheduling. In addition, the traffic manager 104 may be further configured to deal with multicast and associated packet replication. In addition to the typical traffic management functions, the traffic manager 104 in this embodiment may further transmit at least one parameter representative of at least one action command set (i.e., at least one parameterized action command set composed of parameter(s) only) from the ingress packet processing circuit 102 to the egress packet processing circuit 106. Specifically, the ingress packet processing circuit 102 may be further configured to process an ingress packet received from an ingress port to generate at least one parameter, where the at least one parameter may be derived from the identified packet header of the ingress packet. The egress packet processing circuit 106 may be further configured to refer to the at least one parameter to determine the at least one action command set, and execute the at least one action command set for generating an egress packet to be forwarded through an egress port. By way of example, but not limitation, the at least one action command set may include one or more packet modification commands/instructions for modifying an ingress packet to generate an egress packet.

It should be noted that the size of the at least one parameter generated and transmitted by the ingress packet processing circuit 102 is smaller than the size of the at least one action command set recovered and executed on the egress packet processing circuit 106. For example, all operators and operands included in the at least one action command set are parameterized. Compared to the conventional network switch design which transmits large-sized action command sets from an ingress packet processing circuit to an egress packet processing circuit through a traffic manager, the proposed network switch design of the present invention transits small-sized parameters from the ingress packet processing circuit 102 to the egress packet processing circuit 106 through the traffic manager 104. In other words, the proposed network switch design of the present invention does not transmit large-sized action command sets from the ingress packet processing circuit 102 to the egress packet processing circuit 106 through the traffic manager 104, thus saving the bandwidth usage of the traffic manager 104. Further, the bandwidth requirement of the traffic manager 104 may be relaxed.

As mentioned above, the ingress packet processing circuit 102 is equipped with the packet header extraction and classification capability. In one exemplary design, the ingress packet processing circuit 102 may identify a packet header of an ingress packet, and then look up the at least one first look-up table 111 (which may include one or more programmable tables) based on the identified packet header to directly determine the at least one parameter representative of the at least one action command set to be executed for applying packet modification(s) to the ingress packet. In another exemplary design, the ingress packet processing circuit 102 may identify a packet header of an ingress packet, look up the at least one first look-up table 111 (which may include one or more programmable tables) based on the identified packet header to determine the at least one action command set to be executed for applying packet modification to the ingress packet, and parameterize the at least one action command set to generate the at least one parameter representative of the at least one action command set. In short, any means capable of transferring large-sized action command sets into small-sized parameters for transmission may be employed by the ingress packet processing circuit 102.

Further, as mentioned above, the egress packet processing circuit 106 is equipped with the action command execution capability. In one exemplary design, the egress packet processing circuit 106 may receive the at least one parameter transmitted from the ingress packet processing circuit 102 through the traffic manager 104, and then look up the at least one second look-up table 112 (which may include one or more programmable tables) based on the received at least one parameter to determine the at least one action command set. Next, the egress packet processing circuit 106 executes the at least one action command set for applying packet modification (s) to the ingress packet to generate an egress packet.

By way of example, but not limitation, the parameter(s) mentioned above could include a port number of the ingress port, or a port number of the egress port, or a VLAN (Virtual Local Area Network) tag (or VLAN identifier (VID)), or a protocol type, a Network Identifier in a communication channel (e.g., a network identifier in a tunnel header), or a combination thereof.

In this embodiment, the processor 108 may properly program the at least one first look-up table 111 and the at least one second look-up table 112, such that the at least one parameter generated in response to the identified packet header of the ingress packet is recognizable to the egress packet processing circuit 106 and can be used by the egress packet processing circuit 106 to reconstruct the at least one action command set.

For better understanding of technical features of the present invention, several exemplary action command parameterization designs are given as below.

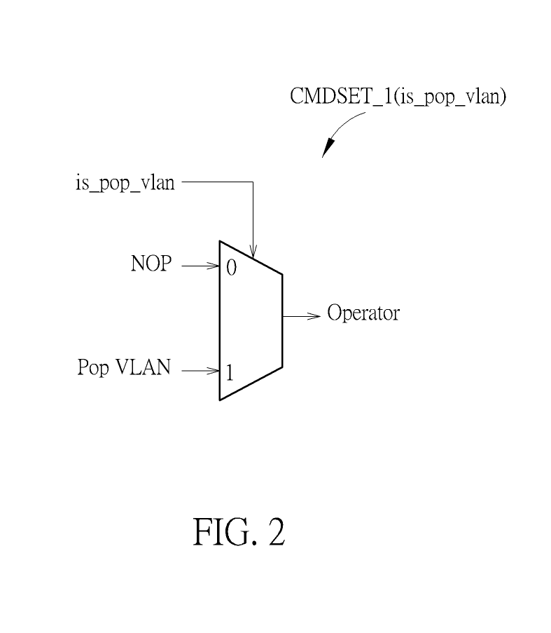

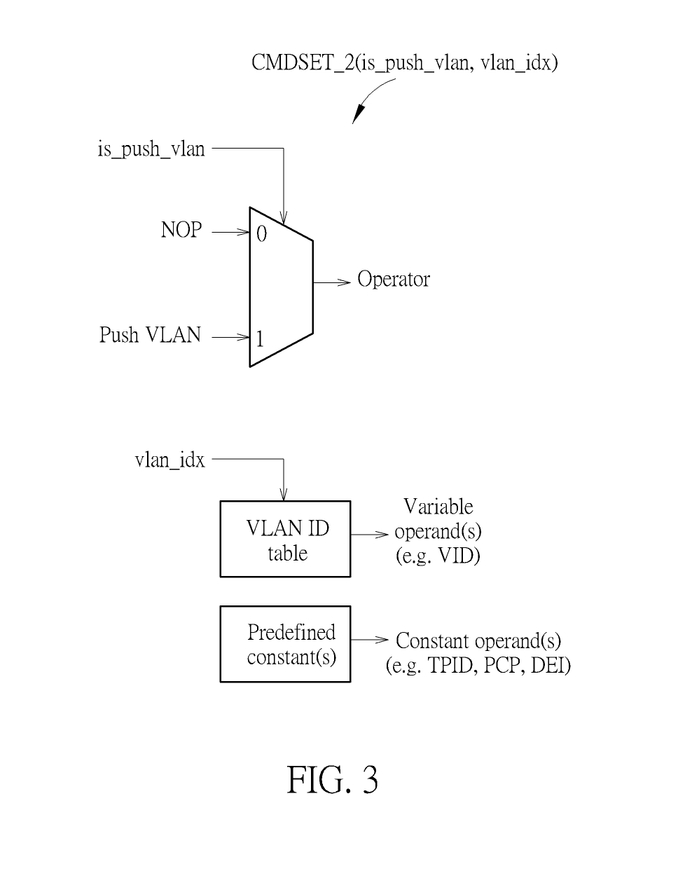

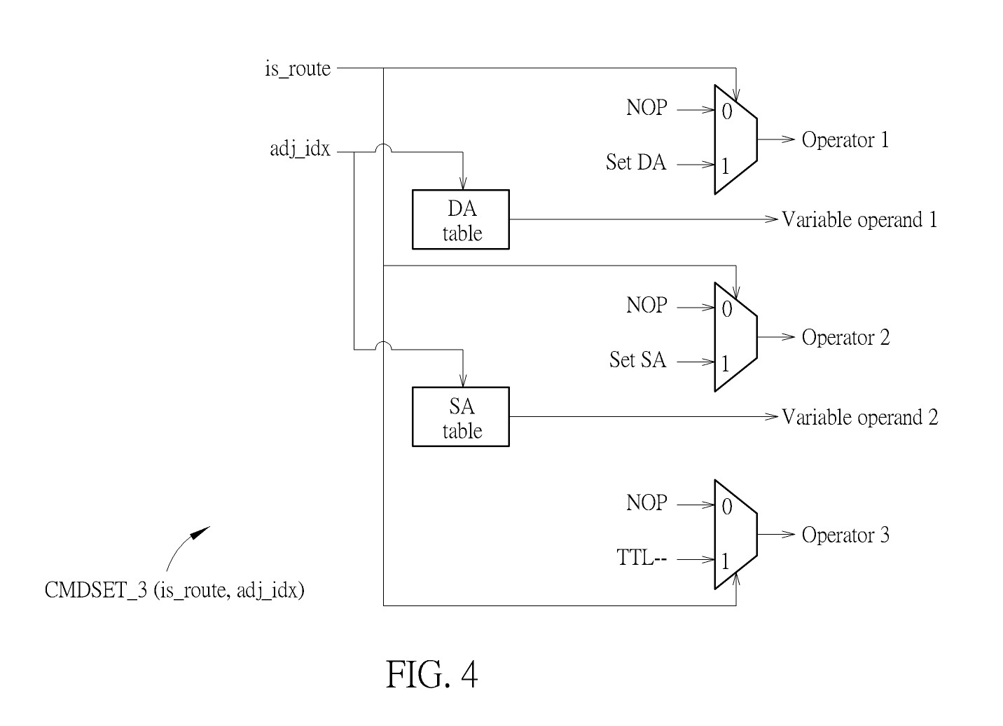

Please refer to FIG. 2, FIG. 3 and FIG. 4. FIG. 2 is a diagram illustrating a first action command set determined at the egress packet processing circuit 106 based on a single first parameter included in the at least one parameter generated from the ingress packet processing circuit 102 according to an embodiment of the present invention. FIG. 3 is a diagram illustrating a second action command set determined at the egress packet processing circuit 106 based on two second parameters included in the at least one parameter generated from the ingress packet processing circuit 102 according to an embodiment of the present invention. FIG. 4 is a diagram illustrating a third action command set determined at the egress packet processing circuit 106 based on two third parameters included in the at least one parameter generated from the ingress packet processing circuit 102 according to an embodiment of the present invention. In accordance with this exemplary action command parameterization design, the at least one parameter generated in response to the identified packet header of the ingress packet includes a plurality of parameters used to control execution of a plurality of different action command sets at the egress packet processing circuit 106. For example, the packet modification instructions to be applied to an ingress packet to generate an egress packet may be categorized into different action command sets, where each of the action command sets may be determined at the egress packet processing circuit 106 based on associated parameter(s) generated and transmitted from the ingress packet processing circuit 102 through the traffic manager 104.

As shown in FIG. 2, the first action command set CMDSET_1 controls whether a VLAN (Virtual Local Area Network) tag (or VLAN identifier (VID)) included in a packet header of an ingress packet should be removed. An operator of the first action command set CMDSET_1 may be set by a Pop (“remove”) VLAN instruction or a NOP (No Operation) instruction, depending upon the value of the first parameter is_pop_vlan set by the ingress packet processing circuit 102.

For example, when is_pop_vlan=1, the first action command set CMDSET_1 is set by the Pop VLAN instruction. Hence, when the first action command set CMDSET_1 is executed by the egress packet processing circuit 106 to generate the egress packet, the VLAN tag (or VID) included in the packet header of the ingress packet is removed. When is_pop_vlan=0, the first action command set CMDSET_1 is set by the NOP instruction. Hence, when the first action command set CMDSET_1 is executed by the egress packet processing circuit 106 to generate the egress packet, the VLAN tag (or VID) included in the packet header of the ingress packet remains intact.

As shown in FIG. 3, the second action command set CMDSET_2 controls whether a VLAN tag (or VID) should be added to an ingress packet before forwarding. When determining that the VLAN tag (or VID) should be added, the second action command set CMDSET_2 further controls the operation of adding the VLAN tag (or VID) to the ingress packet to be forwarded. An operator of the second action command set CMDSET_2 may be set by a Push (“add”) VLAN instruction or a NOP instruction, depending upon the value of the second parameter is_push_vlan set by the ingress packet processing circuit 102.

For example, when is_push_vlan=1, the second action command set CMDSET_2 is set by the Push VLAN instruction. Hence, when the second action command set CMDSET_2 is executed by the egress packet processing circuit 106 to generate the egress packet, additional VLAN-related information is intentionally added to the ingress packet to be forwarded, where the additional VLAN-related information may be a variable operand used by the Push VLAN instruction such as a VLAN tag (or VID), or may be a constant operand used by the Push VLAN instruction such as a tag protocol identifier (TPID), a Priority Code Point (PCP), or a Drop Eligibility Indicator (DEI). Concerning the variable operand, it may be set by looking up a VLAN ID table (which may be included in the at least one second look-up table 112) based on another second parameter vlan_idx set by the ingress packet processing circuit 102.

Regarding the second parameter is_push_vlan, it controls whether a VLAN tag (or VID) should be added to an ingress packet to be forwarded. Regarding the other second parameter vlan_idx, it controls the operation of adding the VLAN tag (or VID) to the ingress packet to be forwarded. In this example, a VLAN tag (or VID) to be added to an ingress packet is a variable operand rather than a constant operand. Hence, different ingress packets may have different VLAN tags (or VIDs) added thereto. The second parameter vlan_idx is therefore used to select a VLAN tag (or VID) from the VLAN ID table. Concerning any constant operand of the Push VLAN instruction, it is a predefined constant. Hence, when is_push_vlan=1, the predefined constant can be directly used as one operand of the Push VLAN instruction.

However, when is_push_vlan=0, the second action command set CMDSET_2 is set by the NOP instruction without using any operands. Hence, when the second action command set CMDSET_2 is executed by the egress packet processing circuit 106 to generate the egress packet, no additional VLAN-related information is intentionally added to the ingress packet to be forwarded.

As shown in FIG. 4, the third action command set CMDSET_3 controls whether an ingress packet generated from a source network device should be routed to at least one destination network device. When determining that the ingress packet should be routed, the third action command set CMDSET_3 further controls the packet routing operation. The third action command set CMDSET_3 includes multiple operators. The first operator of the third action command set CMDSET_3 may be set by a Set DA (Destination Address) instruction or a NOP instruction, depending upon the value of the third parameter is_route set by the ingress packet processing circuit 102.

For example, when is_route=1, the first operator of the third action command set CMDSET_3 is set by the Set DA instruction. Hence, when the third action command set CMDSET_3 is executed by the egress packet processing circuit 106 to generate the egress packet, the destination address included in the packet header of the ingress packet to be forwarded is modified, where the destination address set by the Set DA instruction may be a first variable operand determined by looking up a DA table (which may be included in the at least one second look-up table 112) based on another third parameter adj_idx set by the ingress packet processing circuit 102. When is_route=0, the first operator of the third action command set CMDSET_3 is set by the NOP instruction. Hence, when the third action command set CMDSET_3 is executed by the egress packet processing circuit 106 to generate the egress packet, no modification is made to the destination address included in the packet header of the ingress packet to be forwarded.

The second operator of the third action command set CMDSET_3 may be set by a Set SA (Source Address) instruction or a NOP instruction, depending upon the value of the same third parameter is_route mentioned above. For example, when is_route=1, the second operator of the third action command set CMDSET_3 is set by the Set SA instruction. Hence, when the third action command set CMDSET_3 is executed by the egress packet processing circuit 106 to generate the egress packet, the source address included in the packet header of the ingress packet to be forwarded is modified, where the source address set by the Set SA instruction may be a second variable operand determined by looking up an SA table (which may be included in the at least one second look-up table 112) based on the third parameter adj_idx mentioned above. When is_route=0, the second operator of the third action command set CMDSET_3 is set by the NOP instruction. Hence, when the third action command set CMDSET_3 is executed by the egress packet processing circuit 106 to generate the egress packet, no modification is made to the source address included in the packet header of the ingress packet to be forwarded.

The third operator of the third action command set CMDSET_3 may be set by a TTL—instruction or a NOP instruction, depending upon the value of the same third parameter is_route mentioned above. For example, when is_route=1, the third operator of the third action command set CMDSET_3 is set by the TTL—instruction. Hence, when the third action command set CMDSET_3 is executed by the egress packet processing circuit 106 to generate the egress packet, the time to live (TTL) value is decreased by one. When is_route=0, the third operator of the third action command set CMDSET_3 is set by the NOP instruction. Hence, when the third action command set CMDSET_3 is executed by the egress packet processing circuit 106 to generate the egress packet, the TTL value remains intact.

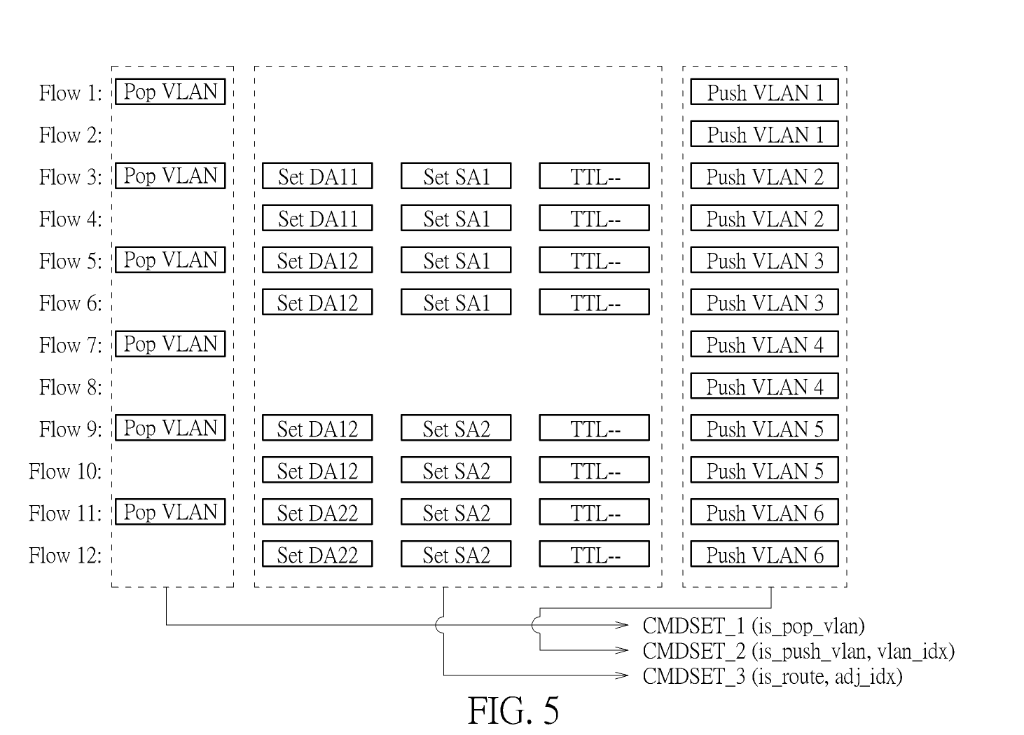

Based on parameters associated with these action command sets CMDSET_1, CMDSET_2, and CMDSET_3, the action commands involved in generating an egress packet to an egress port are determined and then executed by the egress packet processing circuit 106. In other words, different settings of the parameters would result in different action commands executed by the egress packet processing circuit 106. Please refer to FIG. 5, which is a diagram illustrating different combinations of action commands determined by the action command sets CMDSET_1, CMDSET_2, and CMDSET_3. Hence, based on the identified packet header of the ingress packet, the ingress packet processing circuit 102 properly sets the parameters, including is_pop_vlan, is_push_vlan, vlan_idx, is_route and adj_idx. In this way, a desired combination of action commands for egress packet generation is determined at the egress packet processing circuit 106 according to the parameters transmitted from the ingress packet processing circuit 102 through the traffic manager 104. As shown in FIG. 5, five parameters are able to determine at least twelve packet flows each having a different combination of action commands.

Compared to the conventional design which transmit twelve combinations of action commands from an ingress packet processing circuit to an egress packet processing circuit through a traffic manager, the present invention only transmits five parameters for each combination of action commands, where the parameter is_pop_vlan decides the 1^{st} command, the parameters is_push_vlan and vlan_idx decide the 2^{nd} command, the 3^{rd} command and the 4^{th} command, and the parameters is_route and adj_idx decide the 5^{th} command. Hence, the action command explosion issue can be avoided/mitigated by using the proposed action command parameterization design.

For example, considering a case where a first action command may be set by one of M action commands, each having one command setting of the first action command, and a second action command may be set by one of N action commands, each having one command setting of the second action command, there may be (M×N) combinations of the first action command and the second command. When receiving one ingress packet, the conventional design transmits one of (M×N) combinations of the first action command and the second action command from an ingress packet processing circuit to an egress packet processing circuit through a traffic manager. As a result, the conventional design needs to record (M×N) combinations of the first action command and the second action command and then select one command combination from the (M×N) combinations of the first action command and the second action command, which results in an action command explosion issue.

In accordance with the proposed action command parameterization design of the present invention, the first action command can be parameterized into first parameter(s), the second action command can be parameterized into second parameter(s), and the first parameter(s) and the second parameter(s) are transmitted from the ingress packet processing circuit 102 to the egress packet processing circuit 106 through the traffic manager 104. The egress packet processing circuit 106 can identify the first action command by referring to the first parameter(s) to select one of the M action commands, each having one command setting of the first action command and recorded in the second look-up table 112, and can identify the second action command by referring to the second parameter(s) to select one of the N action commands, each having one command setting of the second action command and recorded in the second look-up table 112. In other words, the egress packet processing circuit 106 records (M+N) action commands, and uses the (M+N) action commands to reconstruct any of the (M×N) combinations of the first action command and the second command. Hence, by using the proposed action command parameterization design, determining a command set from (M×N) command sets may be transferred to determining a command set from (M+N) command sets, thus avoiding the action command explosion issue.

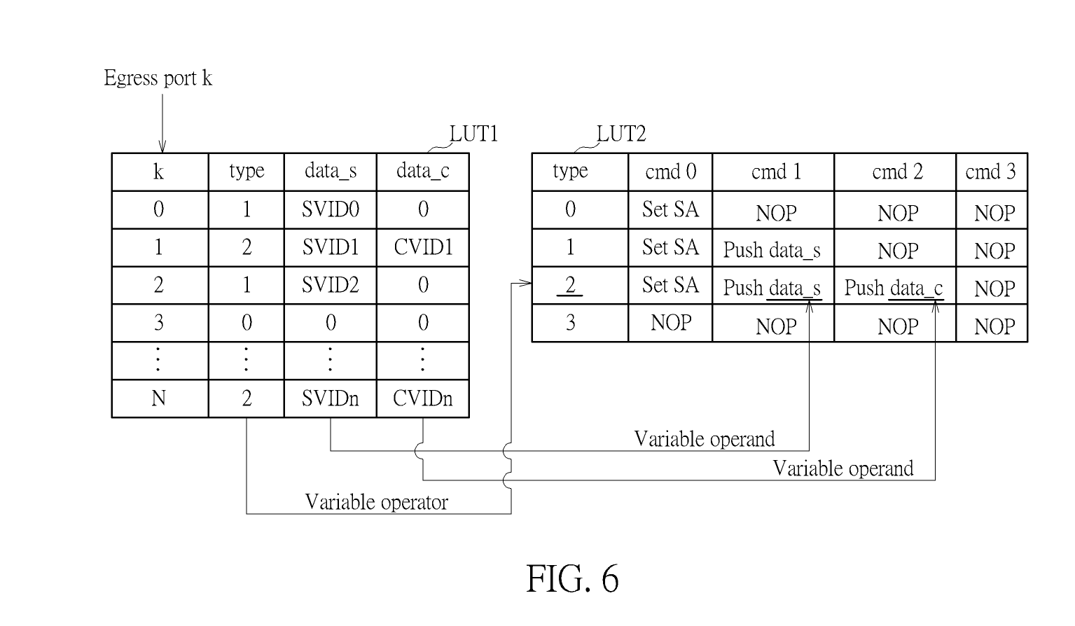

FIG. 6 is a diagram illustrating a first action command set determined at the egress packet processing circuit 106 based on a single parameter generated from the ingress packet processing circuit 102 according to an embodiment of the present invention. In accordance with this exemplary action command parameterization design, the at least one parameter generated in response to the identified packet header of the ingress packet includes only a single parameter used to control execution of a plurality of different action commands at the egress packet processing circuit 106. For example, the packet modification instructions to be applied to an ingress packet to generate an egress packet may be determined at the egress packet processing circuit 106 solely based on a single parameter generated and transmitted from the ingress packet processing circuit 102 through the traffic manager 104. In one exemplary design, the single parameter may be a port number of an egress port. However, this is not meant to be a limitation of the present invention. Alternatively, the single parameter may be set by a control value recognizable to the egress packet processing circuit 106 for indicating selection of the desired action command set.

Consider a case where the single parameter is a port number of an egress port from which an egress packet derived from an ingress packet is outputted. As shown in FIG. 6, two tables LUT1 and LUT2 may be included in the at least one second look-up table 112. The egress packet processing circuit 106 first determines a selected type of the action command set and variable operands used by operators of the selected type of the action command set through looking up the table LUT1 based on the single parameter (e.g., the egress port number k), and then determines action command(s) by looking up the other table LUT2 based on the selected type of the action command set. In this exemplary embodiment, a variable operand may be an SVID (service VID) or a CVID (customer VID). In addition, there are four types of the action command set, where the action command set with type=0 includes a Set SA instruction and three NOP instructions; the action command set with type=1 includes a Set SA instruction, a Push SVID instruction, and two NOP instructions; the action command set with type=2 includes a Set SA instruction, a Push SVID instruction, a Push CVID instruction, and an NOP instruction; and the action command set with type=3 includes four NOP instructions. For example, when k=N, the Set SA instruction, the Push SVID instruction with the corresponding variable operand set by SVIDₙ, and the Push CVID instruction with the corresponding variable operand set by CVIDₙ, and an NOP instruction are executed for generating an egress packet to the egress port P_{OUT}_{_{—}}_{N}.

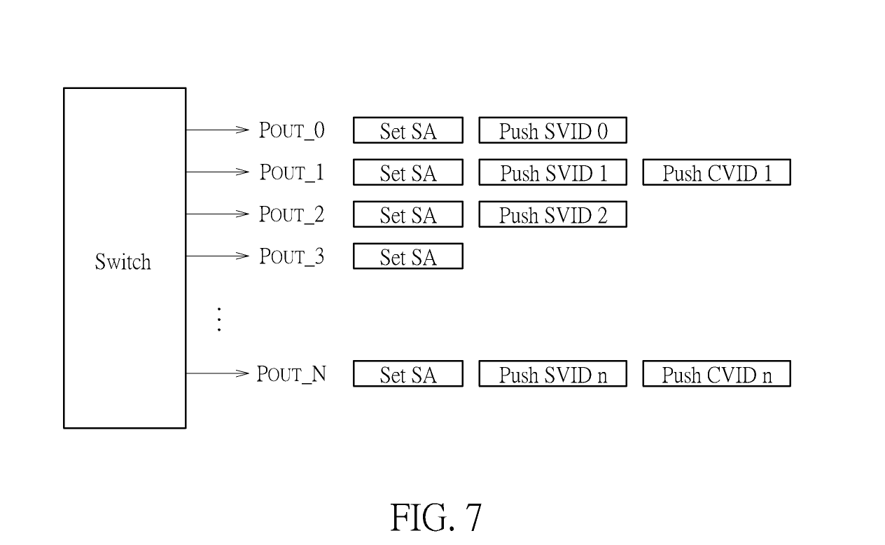

Based on the single parameter associated with the action command set, the action commands involved in generating an egress packet to an egress port with a port number designated by the single parameter are determined and then executed by the egress packet processing circuit 106. In other words, different settings of the single parameter would result in different action commands executed by the egress packet processing circuit 106. Please refer to FIG. 7, which is a diagram illustrating different combinations of action commands determined by different egress port numbers according to the action command parameterization design shown in FIG. 6. Hence, based on the identified packet header of the ingress packet, the ingress packet processing circuit 102 knows an egress port from which an egress packet derived from the ingress packet should be outputted, and properly sets the single parameter by the egress port number. In this way, a desired combination of action commands for the ingress packet is determined at the egress packet processing circuit 106 according to the single parameter transmitted through the traffic manager 104. As shown in FIG. 6 and FIG. 7, four types of the action command set can be used to determine (N+1) packet flows for different egress ports. Hence, the action command explosion issue is avoided/mitigated by using the proposed action command parameterization design.

As mentioned above, the tables LUT1 and LUT2 may be included in the at least one second look-up table 112. Hence, each of the tables LUT1 and LUT2 may be programmed by the processor 108 to meet different application requirements. For example, a new action command may be added, and/or an existing action command may be removed.

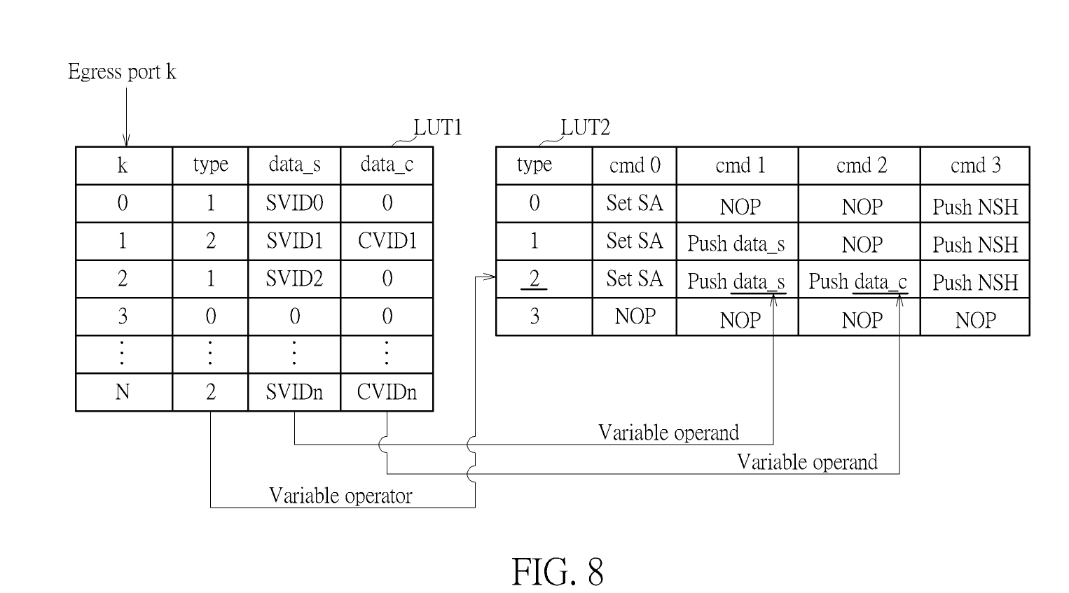

FIG. 8 is a diagram illustrating a second action command set determined at the egress packet processing circuit 106 based on a single parameter generated from the ingress packet processing circuit 102 according to an embodiment of the present invention. In accordance with this exemplary action command parameterization design, the at least one parameter generated in response to the identified packet header of the ingress packet includes only a single parameter used to control execution of a plurality of different action commands at the egress packet processing circuit 106. The major difference between the embodiments shown in FIG. 6 and FIG. 8 is that the table LUT2 of FIG. 8 is programmed to include a Push NSH (network service header) instruction for types 0-2 of the action command set. Specifically, as shown in FIG. 8, the action command set with type=0 includes a Set SA instruction, two NOP instructions, and a Push NSH instruction; the action command set with type=1 includes a Set SA instruction, a Push SVID instruction, an NOP instruction, and a Push NSH instruction; and the action command set with type=2 includes a Set SA instruction, a Push SVID instruction, a Push CVID instruction, and a Push NSH instruction. In this example, the action command set with type=3 still keeps four NOP instructions.

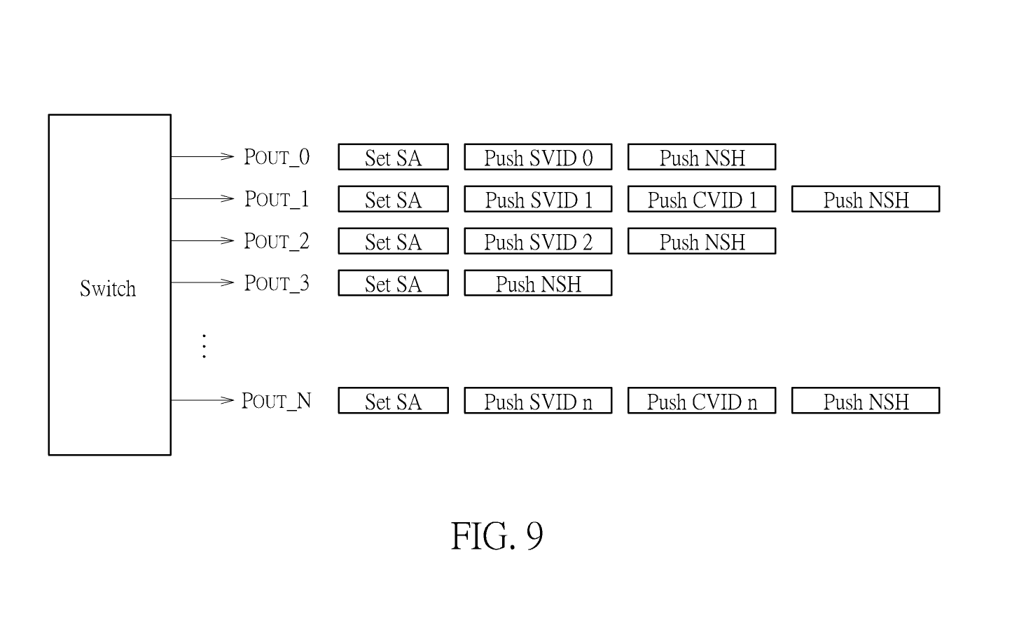

As mentioned above, based on the single parameter associated with the action command set, the action commands involved in generating an egress packet to an egress port with a port number designated by the single parameter are determined and then executed by the egress packet processing circuit 106. Hence, different settings of the singer parameter would result in different action commands executed by the egress packet processing circuit 106. Please refer to FIG. 9, which is a diagram illustrating different combinations of action commands determined by different egress port numbers according to the action command parameterization design shown in FIG. 8. Hence, based on the identified packet header of the ingress packet, the ingress packet processing circuit 102 knows an egress port from which an egress packet derived from the ingress packet should be outputted, and properly sets the single parameter by the egress port number. In this way, a desired combination of action commands for the ingress packet is determined at the egress packet processing circuit 106 according to the single parameter transmitted through the traffic manager 104. Further, as shown in FIG. 8 and FIG. 9, four types of the action command set can be used to determine (N+1) packet flows for different egress ports. Hence, the action command explosion issue is avoided/mitigated by using the proposed action command parameterization design.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A packet processing apparatus, comprising:
an ingress packet processing circuit, configured to process an ingress packet received from an ingress port to generate at least one parameter;
an egress packet processing circuit, comprising at least one programmable look-up table, wherein the egress packet processing circuit is configured to refer to the at least one parameter to determine at least one action command set, and execute the at least one action command set for generating an egress packet to be forwarded through an egress port;
a traffic manager, coupled between the ingress packet processing circuit and the egress packet processing circuit; and
a processor, configured to program the at least one programmable look-up table;
wherein no action command in the at least one action command set is transmitted from the ingress packet processing circuit to the egress packet processing circuit through the traffic manager.

2. The packet processing apparatus of claim 1, wherein a size of the at least one parameter transmitted from the ingress packet processing circuit is smaller than a size of the at least one action command set executed on the egress packet processing circuit.

3. The packet processing apparatus of claim 1, wherein the at least one parameter comprises a plurality of parameters used to control execution of a plurality of different action command sets.

4. The packet processing apparatus of claim 1, wherein the at least one parameter comprises only a single parameter, and the single parameter is used to control execution of a plurality of different action commands.

5. The packet processing apparatus of claim 1, wherein the at least one parameter comprises a port number of at least one of the egress port and the ingress port.

6. The packet processing apparatus of claim 1, wherein the at least one parameter comprises at least one of a virtual local area network (VLAN) tag, a protocol type, and a network identifier in a communication channel.

7. The packet processing apparatus of claim 1, wherein the egress packet processing circuit determines the at least one action command set through looking up the at least one programmable look-up table.

8. A packet processing apparatus, comprising:
an ingress packet processing circuit, comprising at least one programmable look-up table, wherein the ingress packet processing circuit is configured to process an ingress packet received from an ingress port to generate at least one parameter;
an egress packet processing circuit, configured to refer to the at least one parameter to determine at least one action command set, and execute the at least one action command set for generating an egress packet to be forwarded through an egress port;
a traffic manager, coupled between the ingress packet processing circuit and the egress packet processing circuit; and
a processor, configured to program the at least one programmable look-up table;
wherein no action command in the at least one action command set is transmitted from the ingress packet processing circuit to the egress packet processing circuit through the traffic manager.

9. The packet processing apparatus of claim 8, wherein a size of the at least one parameter transmitted from the ingress packet processing circuit is smaller than a size of the at least one action command set executed on the egress packet processing circuit.

10. The packet processing apparatus of claim 8, wherein the at least one parameter comprises a plurality of parameters used to control execution of a plurality of different action command sets.

11. The packet processing apparatus of claim 8, wherein the at least one parameter comprises only a single parameter, and the single parameter is used to control execution of a plurality of different action commands.

12. The packet processing apparatus of claim 8, wherein the at least one parameter comprises a port number of at least one of the egress port and the ingress port.

13. The packet processing apparatus of claim 8, wherein the at least one parameter comprises at least one of a virtual local area network (VLAN) tag, a protocol type, and a network identifier in a communication channel.

14. The packet processing apparatus of claim 8, wherein the ingress packet processing circuit determines the at least one parameter through looking up the at least one programmable look-up table.

15. A packet processing apparatus, comprising:
an ingress packet processing circuit, configured to process an ingress packet received from an ingress port to generate at least one parameter;
an egress packet processing circuit, configured to refer to the at least one parameter to set at least one action command set, and execute the at least one action command set for generating an egress packet to be forwarded through an egress port; and
a traffic manager, coupled between the ingress packet processing circuit and the egress packet processing circuit;
wherein the packet processing apparatus is a software-defined networking (SDN) switch; and no action command in the at least one action command set is transmitted from the ingress packet processing circuit to the egress packet processing circuit through the traffic manager.

16. The packet processing apparatus of claim 15, wherein a size of the at least one parameter transmitted from the ingress packet processing circuit is smaller than a size of the at least one action command set executed on the egress packet processing circuit.

17. The packet processing apparatus of claim 15, wherein the at least one parameter comprises a plurality of parameters used to control execution of a plurality of different action command sets.

18. The packet processing apparatus of claim 15, wherein the at least one parameter comprises only a single parameter, and the single parameter is used to control execution of a plurality of different action commands.

19. The packet processing apparatus of claim 15, wherein the at least one parameter comprises a port number of at least one of the egress port and the ingress port.

20. The packet processing apparatus of claim 15, wherein the at least one parameter comprises at least one of a virtual local area network (VLAN) tag, a protocol type, and a network identifier in a communication channel.
